(19) United States
(12) Patent Application Publication
(10) Pub. No.: US 2011/0130169 A1
(43) Pub. Date: Jun. 2, 2011

(54) CARD DEVICE FOR MOBILE WIRELESS COMMUNICATION TERMINAL

(75) Inventor: SHOGO ARIMURA, Tokyo (JP)

(73) Assignee: MITSUMI ELECTRIC CO., LTD.

(21) Appl. No.: 12/957,580

(22) Filed: Dec. 1, 2010

(30) Foreign Application Priority Data
Dec. 2, 2009 (JP) 2009-274974

(51) Int. Cl. H04B 1/38

(52) U.S. Cl. 455/558

(57) ABSTRACT

A card device for mounting in a mobile wireless communication terminal having an antenna includes a card substrate having a multilayer configuration. The card substrate includes a surface wiring layer on which an antenna terminal is formed for connecting to the antenna, and another wiring layer facing the surface wiring layer and being at ground potential. The other wiring layer includes a conductor notch part formed at a position corresponding to a position of the antenna terminal.

### BACKGROUND OF THE INVENTION

1. Field of the Invention

The present invention relates to a card device for a mobile wireless communication terminal.

2. Description of the Related Art

Mobile communication terminals such as mobile phones are commonly equipped with a wireless function such as an infrared communication function or a Bluetooth (Registered Trademark) communication function for transferring data at a short range distance (short range data transfer). It is desired for the mobile communications terminals to be further equipped with a wireless function for transferring data at a midrange distance (midrange data transfer).

In a case of adding a wireless LAN function to the mobile communication terminal, a wireless LAN card is used. The wireless LAN card may be, for example, a card device (e.g., micro-SD card) that includes a wireless LAN circuit block having an antenna terminal. By mounting the wireless LAN card in a mobile wireless communication terminal, the antenna terminal of the wireless LAN card can connect with an antenna of the mobile wireless communication terminal.

For example, Japanese Laid-Open Publication No. 2000-60160 discloses a technology including a mobile wireless terminal and a card device for preventing antenna characteristics from deteriorating and preventing degradation of operability by the user. The mobile wireless communication terminal includes an antenna for communicating with the card device and a mobile wireless communication terminal contact point (contact point of the wireless communication terminal) electrically connected to the antenna. The card device includes a matching circuit corresponding to a predetermined wireless function and a card device contact point (contact point of the card device) electrically connected to the matching circuit and configured to contact the antenna of the mobile wireless communication terminal when the card device is mounted in the mobile wireless communication terminal.

A card substrate used for a wireless LAN may be, for example, a multi-wiring layer card having a thickness of approximately 0.2 mm. In this case, a metal pad serving as an antenna terminal is provided on the surface of the card substrate. However, in a case where a conductor plane (ground plane) exists in one of the wiring layers inside the card substrate at a position corresponding to the position of the metal pad, the short distance between the metal pad and the ground plane and the high frequency bandwidth of 2.4 GHz used for wireless LAN causes the impedance of the antenna terminal to significantly decrease. Such decrease of impedance occurring causes a mismatch of impedance of antenna terminals. This results in problems such as reflection of transmission/reception signals and degradation of the transmission/reception signals.

### SUMMARY OF THE INVENTION

The present invention may provide a card device for a mobile wireless communication terminal that substantially eliminates one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by a card device for a mobile wireless communication terminal particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a card device for mounting in a mobile wireless communication terminal including an antenna, the card device including: a card substrate having a multilayer configuration; wherein the card substrate includes a surface wiring layer on which an antenna terminal is formed for connecting to the antenna, and another wiring layer facing the surface wiring layer and being at ground potential, wherein the other wiring layer includes a conductor notch part formed at a position corresponding to a position of the antenna terminal.

Other objects, features and advantages of the present invention will become more apparent from the following detailed description when read in conjunction with the accompanying drawings.

### BRIEF DESCRIPTION OF THE DRAWINGS

FIGS. 1A and 1B are plan views illustrating a mobile wireless communication terminal and a wireless LAN card according to an embodiment of the present invention;

FIG. 2 is a schematic diagram illustrating a mobile wireless communication terminal and a wireless LAN card according to an embodiment of the present invention;

FIG. 3 is a block diagram illustrating a wireless LAN card according to an embodiment of the present invention;

FIG. 4 is a cross-sectional view illustrating a card substrate of a wireless LAN card according to an embodiment of the present invention;

FIG. 5 is a plan view illustrating an antenna terminal part according to an embodiment of the present invention;

FIG. 6 is a plan view illustrating an antenna terminal part of a third wiring layer according to an embodiment of the present invention;

FIG. 7 is a plan view illustrating a third wiring layer having no conductor removing part according to an embodiment of the present invention;

FIG. 8 is a plan view illustrating an antenna terminal part according to another embodiment of the present invention; and

FIG. 9 is a graph illustrating impedance characteristics.

### DETAILED DESCRIPTION OF THE PREFERRED EMBODIMENTS

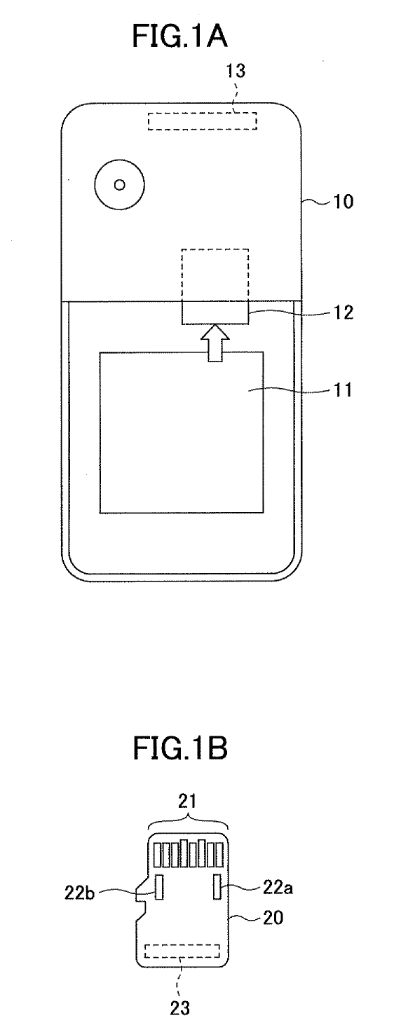

FIG. 1A is a plan view illustrating a mobile communication terminal 10 according to an embodiment of the present invention. In FIG. 1A, the mobile communication terminal 10 is in a state having a back surface cover removed therefrom. A connector used for connecting with a card device (hereinafter also referred to as “card device connector”) 12 is provided inside the mobile communication terminal 10. In this example, the card device connector 12 is provided in the vicinity of a battery pack 11. In this embodiment, the card device is a wireless LAN card 20. The wireless LAN card 20 is mounted in the mobile communication terminal 10 by inserting the wireless LAN card 20 in an arrow direction illustrated in FIG. 1A. The wireless LAN card 20 can be freely attached to and detached from the mobile communication terminal 10.

An antenna 13 is provided inside the mobile communication terminal 10. In this embodiment, the antenna 13 is used for Bluetooth (Registered Trademark) and communicates in a frequency bandwidth of 2.4 GHz. Antennas besides the antenna 13 may also be provided inside the mobile communication terminal 10. For example, an antenna for mobile communications or a one-segment antenna for digital terrestrial broadcasting may be provided inside the mobile communication terminal 10.

FIG. 1B is a plan view illustrating a wireless LAN card 20 serving as a card device according to an embodiment of the present invention. In this embodiment, the wireless LAN card 20 is a micro-SD card. In addition to having eight terminals 21 based on the micro-SD card standard, the wireless LAN card 20 also has two terminals 22a and 22b. The eight terminals 21 include one power supply terminal, one ground terminal, four data terminals, one clock terminal, and one command terminal. The terminal 22a is a ground terminal, and the terminal 22b is an antenna terminal. Further, an antenna 23 is provided inside the wireless LAN card 20 to be used for wireless LAN communications communicating in a frequency bandwidth of 2.4 GHz.

The wireless LAN used in this embodiment is based on IEEE 802.11b/g standard and communicates in a frequency bandwidth of 2.4 GHz. Bluetooth (Registered Trademark) also uses the same frequency bandwidth (2.4 GHz) as the wireless LAN.

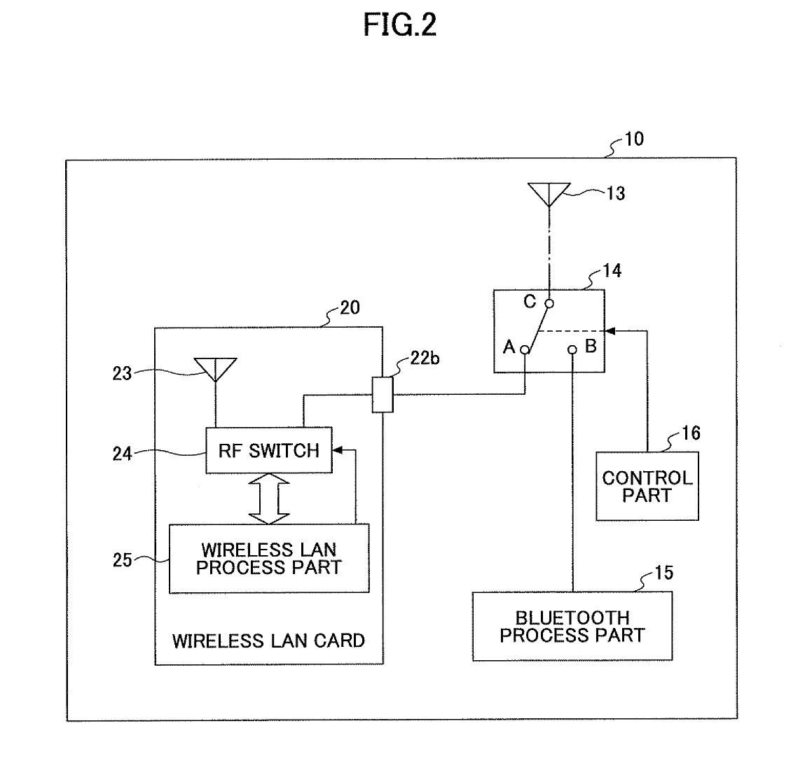

FIG. 2 is a schematic diagram illustrating the mobile communication terminal 10 and the wireless LAN card 20 according to an embodiment of the present invention. In the wireless LAN card 20, the antenna 23 and the antenna terminal 22b are connected to an RF switch 24. Further, the RF switch 24 is connected to a wireless LAN process part 25. The RF switch 24 is controlled by the wireless LAN process part 25. Based on the controls from the wireless LAN process part 25, the RF switch connects the antenna 23 or the antenna terminal 22b to the wireless LAN process part 25.

The antenna terminal 22b of the wireless LAN card 20 is connected to a terminal A of the RF switch 14 of the mobile communication terminal 10. A Bluetooth process part 15 is connected to a terminal B of the RF switch 14. The antenna 13 is connected to a terminal C of the RF switch 14.

The mobile communication terminal 10 includes a control part 16. The control part 16 is for controlling the entire mobile communication terminal 10. In a case where a user selects a Bluetooth mode, the control part 16 connects the terminals B and C of the RF switch 14, which connects the antenna 13 to the Bluetooth process part 15. Further, in a case where the user selects a wireless LAN mode, the control part 16 connects the terminals A and C of the RF switch, which connects the antenna 13 to the RF switch 24 via the antenna terminal 22b.

It is to be noted that the wireless LAN process part 25 is connected to the control part 16 of the wireless communication terminal 10 via the terminal 21.

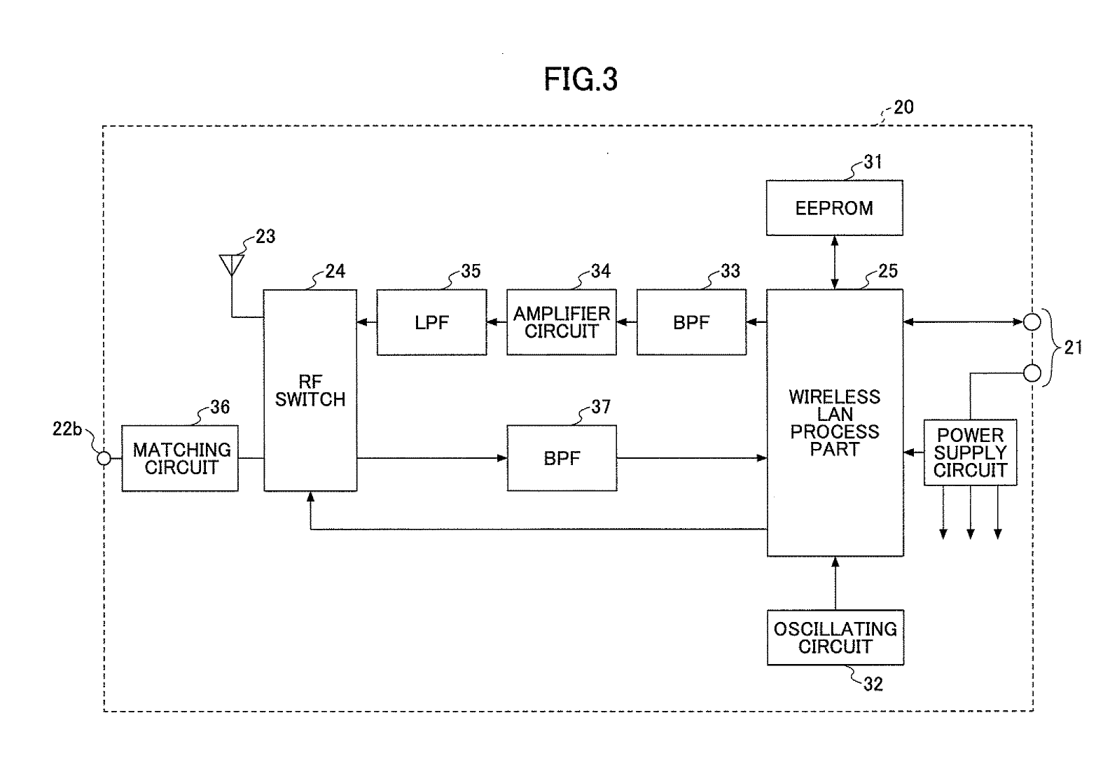

FIG. 3 is a block diagram illustrating the wireless LAN card 20 according to an embodiment of the present invention. In FIG. 3, the wireless LAN card 20 has the wireless LAN process part 25 including a microprocessor. The microprocessor of the wireless LAN process part 25 is connected to an EEPROM 31 to be used as a memory. Further, clocks are supplied from an oscillating circuit 32 to the wireless LAN process part 25. In a case where selection of the wireless LAN mode is reported (instructed) from the control part 16 of the mobile communication terminal 10 to the wireless LAN process part 25 via the terminal 21, the wireless LAN process part 25 performs, for example, an RF (high frequency) signal process, a baseband process, and a MAC process on communication signals (reception signals/transmission signals). Further, the wireless LAN process part 25 controls the switching of the RF switch 24.

Transmission data supplied from, for example, the control part 16 of the mobile communication terminal 10 via the terminal 21 are subject to a MAC process, a baseband process, and an RF signal process by the wireless LAN process part 25 to become transmission signals. The bandwidth of the transmission signals is controlled by a bandwidth filter (BPF, Band Pass Filter) 33 and supplied to an amplifier circuit 34. The transmission signals amplified by the amplifier circuit 34 have unnecessary frequency components removed therefrom by the low pass filter (LPF) 35. Then, the transmission signals are supplied to the RF switch 24 and transmitted from either the antenna 23 or the antenna 13 selected by the RF switch 24.

It is to be noted that a matching circuit 36 is provided between the RF switch 24 and the terminal 22b which is to be connected to the antenna 13 of the mobile communication terminal 10. For example, between the terminal 22b and the RF switch 24, the matching circuit 36 has two capacitors serially connected between the terminal 22b and the RF switch 24 and an inductor connected between the connection point of the two capacitors and ground. The matching circuit 36 performs impedance matching between the RF switch 14 of the mobile communication terminal 10 and the RF switch 24 of the wireless LAN card 20.

The signals received from the antenna 13 or the antenna 23 are selected by the RF switch 24, filtered by a bandpass filter (BPF) 37, and transmitted to the wireless LAN process part 25. The wireless LAN process part 25 performs an RF signal process, a baseband process, and a MAC process on the signals received from the BPF filter 37 and supplied to, for example, the control part 16 of the mobile communication terminal 10 via the terminal 21.

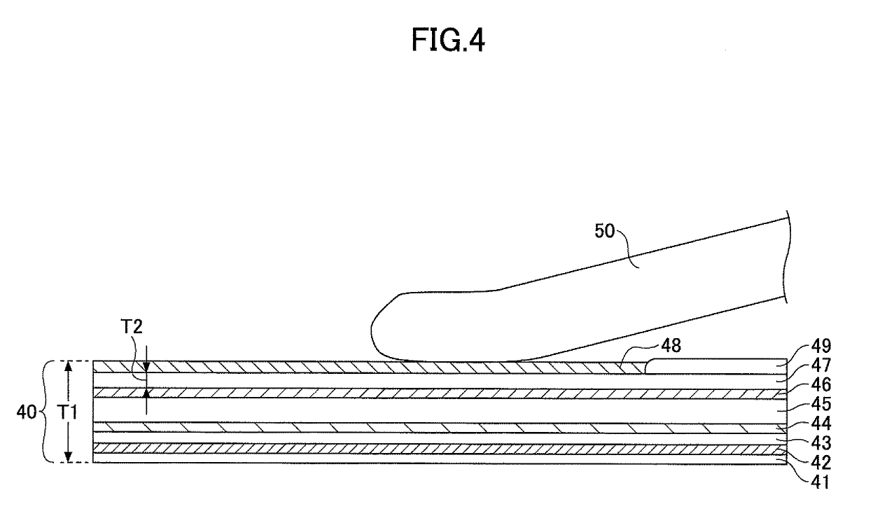

FIG. 4 is a cross-sectional view illustrating a card substrate 40 of the wireless LAN card 20 according to an embodiment of the present invention. More specifically, FIG. 4 illustrates a cross section of the card substrate 40 corresponding to the area of the antenna terminal 22b of the wireless LAN card 20. The card substrate 40 has a multilayer structure including a first insulation layer 41, a first wiring layer 42, a second insulation layer 43, a second wiring layer 44, a third insulation layer 45, a third wiring layer 46, a fourth insulation layer 47, and a fourth wiring layer (surface wiring layer) 48. It is to be noted that a portion of the surface wiring layer 48 is covered by an insulation film 49.

In FIG. 4, the surface wiring layer 48 acts as a metal wiring (land) of the antenna terminal 22b. The card device connector 12 is connected to the wireless LAN card 20 by pressing a lead terminal 50 of the card device connector 12 to the surface wiring layer 48. The thickness T1 of the card substrate 40 is, for example, approximately 0.2 mm. The thickness T2 of the fourth insulation layer 47 is, for example, approximately 0.03 mm.

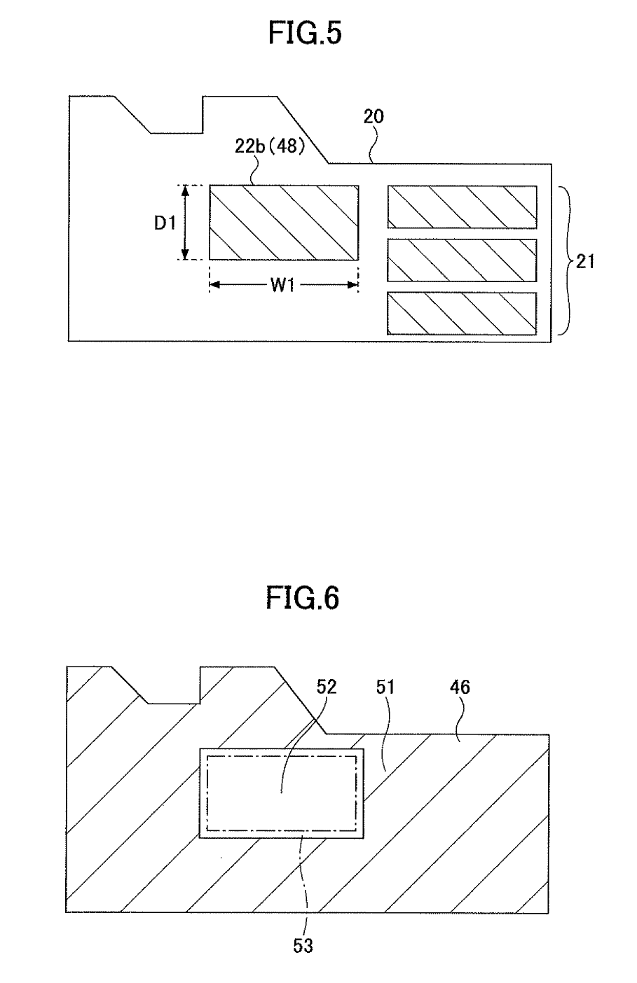

FIG. 5 is a plan view for describing an antenna terminal 22b which is a part of the surface wiring layer 48 of the wireless LAN card 20. FIG. 6 is a plan view illustrating an antenna terminal 22b which is a part of the third wiring layer 46 according to an embodiment of the present invention.

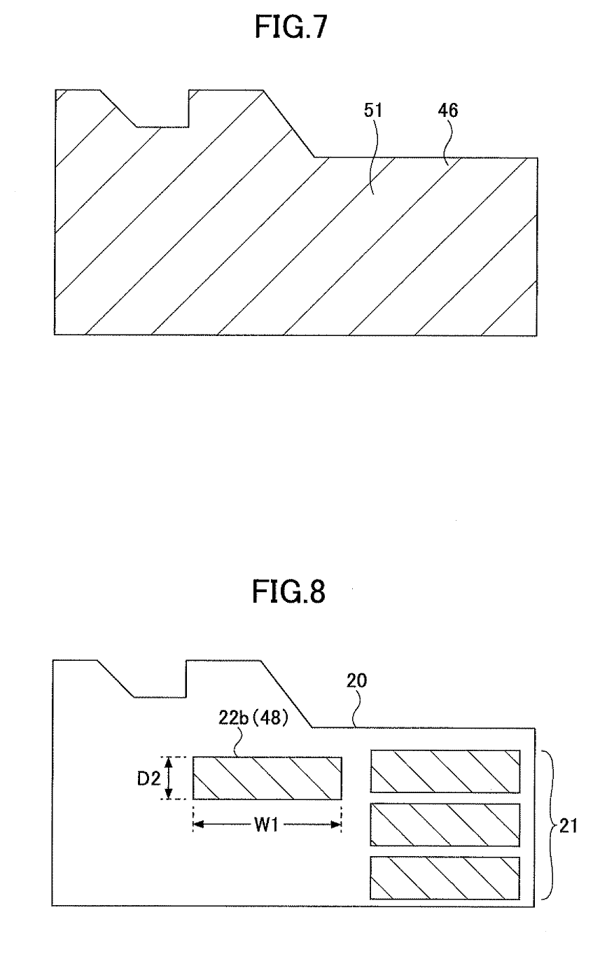

In the example illustrated in FIG. 5, the measurements of a part of the surface wiring layer 48 of the wireless LAN card 20 corresponding to the antenna terminal 22b have a vertical length D1 of 1.4 mm and a horizontal length W1 of 2.9 mm complying to the SDA (SD card Association) standard. In FIG. 6, a conductor notch part 52 is formed at a part of the third wiring layer 46 facing the antenna terminal 22b of the surface wiring layer 48 by removing a conductor 51 (illustrated with a hatching in FIG. 6) at the part of the third wiring layer 46 facing the antenna terminal 22b of the surface wiring layer 48. It is to be noted that the dash-dot line of a rectangle 53 illustrated inside the conductor notch part 52 indicates a contour line of the antenna terminal 22b of FIG. 5. The conductor 51 of the third wiring layer 46 is at ground potential. For the purpose of comparison, FIG. 7 illustrates the third wiring layer 46 without the conductor notch part 52.

Owing to the conductor notch part 52 being formed in the third wiring layer 46 in correspondence with the position of the antenna terminal 22b of the surface wiring layer 48, the impedance of the antenna terminal 22b in the frequency bandwidth used for wireless LAN can be prevented from decreasing.

FIG. 8 is a plan view illustrating a part of the surface wiring layer 48 of the wireless LAN card 20 corresponding to the antenna terminal 22b according to another embodiment of the present invention. The surface wiring layer 48 of the antenna terminal 22b is illustrated in FIG. 8. In FIG. 8, the measurements of a part of the surface wiring layer 48 of the wireless LAN card 20 corresponding to the antenna terminal 22b have a vertical length D2 of 0.7 mm and a horizontal length W1 of 2.9 mm. The area (size) of the antenna terminal 22b illustrated in FIG. 8 is substantially half the size of the antenna terminal 22b illustrated in FIG. 5. In this embodiment, the impedance of the antenna terminal 22b can be prevented from decreasing even where the third wiring layer 46 having no conductor notch part 52 (the third wiring layer 46 illustrated in FIG. 7) is used.

Further, in a case where the third wiring layer 46 including the conductor notch part 52 (illustrated in FIG. 6) is used in a manner facing the antenna terminal 22b of FIG. 8, the impedance of the antenna terminal 22b can be further prevented from decreasing. It is to be noted that in this case, the area in which the conductor 51 is removed is the part of the third wiring layer 46 facing the antenna terminal 22b of FIG. 8.

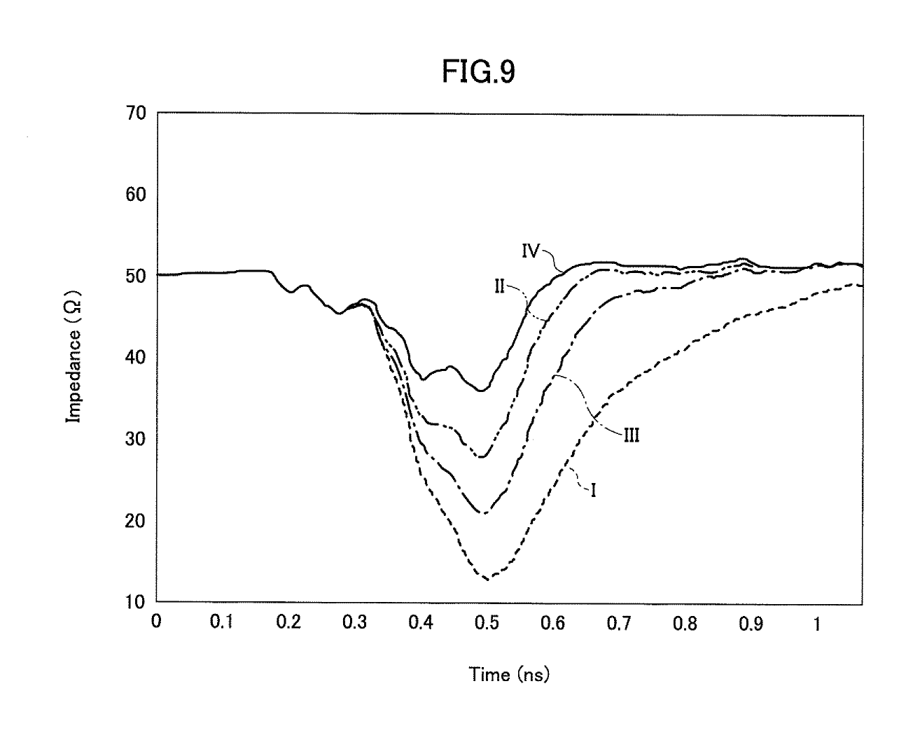

FIG. 9 is a graph for describing impedance characteristics according to impulse response. In this embodiment, the impedance of the antenna 13 in a frequency bandwidth of 2.4 GHz is 50Ω. The broken line I of FIG. 9 indicates the impedance value of a case where the antenna terminal 22b of the surface wiring layer 48 of FIG. 5 and the third wiring layer 46 without the conductor notch part 52 of FIG. 7 are used. The broken line I indicates that the impedance decreases to a minimum impedance value of approximately 13 Ω.

The double-dot chain line II of FIG. 9 indicates the impedance value of a case where the antenna terminal 22b of the surface wiring layer 48 of FIG. 5 and the third wiring layer 46 having the conductor notch part 52 of FIG. 6 are used. The double-dot chain line II indicates that the minimum impedance value is approximately 27 Ω.

The single-dot chain line III of FIG. 9 indicates the impedance value of a case where a small size antenna terminal (smaller than the SDA standard) 22b of the surface wiring layer 48 of FIG. 8 and the third wiring layer 46 without the conductor notch part 52 of FIG. 7 are used. The single-dot chain line III indicates that the minimum impedance value is approximately 21 Ω.

The solid line IV of FIG. 9 indicates the impedance value of a case where the small size antenna terminal (smaller than the SDA standard) 22b of the surface wiring layer 48 of FIG. 8 and the third wiring layer 46 having the conductor notch part 52 of FIG. 6 are used. The solid line IV indicates that the minimum impedance value is approximately 36 Ω.

In a case of forming a wiring at the surface wiring layer 48 of the card substrate 40, a substantial width (predetermined width) is required for the wiring (signal transfer wiring) that is used for transferring (transmitting/receiving) signals from the surface wiring layer 48 of the wireless LAN card 20. The signal transfer wiring may be, for example, a wiring extending from the antenna terminal 22b to the matching circuit 36 or a wiring extending from the antenna 23 to the RF switch 24. Therefore, in a case where the impedance value of the signal transfer wiring decreases to 50Ω or less, the decrease can be prevented by forming a conductor notch part 52 in the conductor of the third wiring layer 46 facing the signal transfer wiring and arranging the conductor in parallel with the signal transfer wiring. It is to be noted that the conductor 51 of the third wiring layer 46 is at ground potential.

The present invention is not limited to the specifically disclosed embodiments, and variations and modifications may be made without departing from the scope of the present invention.

The present application is based on Japanese Priority Application No. 2009274974 filed on Dec. 2, 2009, the entire contents of which are hereby incorporated herein by reference.

What is claimed is:

1. A card device for mounting in a mobile wireless communication terminal including an antenna, the card device comprising:
a card substrate having a multilayer configuration;
wherein the card substrate includes
a surface wiring layer on which an antenna terminal is formed for connecting to the antenna, and
another wiring layer facing the surface wiring layer and being at ground potential,
wherein the other wiring layer includes a conductor notch part formed at a position corresponding to a position of the antenna terminal.

2. The card device as claimed in claim 1, wherein the antenna terminal has an area smaller than an area of an antenna terminal complying to a predetermined card device standard.

3. The card device as claimed in claim 2, wherein the predetermined card device standard is a SDA (SD card Association) standard.

4. A card device for mounting in a mobile wireless communication terminal including an antenna, the card device comprising:
a card substrate having a multilayer configuration;
wherein the card substrate includes a surface wiring layer on which an antenna terminal is formed for connecting to the antenna,
wherein the antenna terminal has an area smaller than an area of an antenna terminal complying to a predetermined card device standard.

5. The card device as claimed in claim 4, wherein the predetermined card device standard is a SDA (SD Card Association) standard.
